(19) United States
(12) Patent Application Publication
(10) Pub. No.: US 2016/0169391 A1
(43) Pub. Date: Jun. 16, 2016

(54) GASKET, AND METHOD OF PRODUCTION AND USAGE THEREOF

(71) Applicant: Carl Freudenberg KG, Weinheim (DE)

(72) Inventors: Juergen EMIG, Grasellenbach (DE); Simon WATLING, Blyth (GB); Matt BILLANY, Washington (GB); Paul WADDELL, North Shields (GB); Ross DIXON, Newcastle Upon Tyne (GB)

(21) Appl. No.: 14/963,632

(22) Filed: Dec. 9, 2015

(30) Foreign Application Priority Data
Dec. 12, 2014 (DE) 102014018287.8

(51) Int. Cl. F16J 15/3276; F16J 15/3204; B29C 43/20; B29C 45/00; B29C 45/16; F16J 15/328; F16J 15/3284

(52) U.S. Cl. CPC F16J 15/3276; F16J 15/328; F16J 15/3204; F16J 15/3284; B29C 45/0003; B29C 45/16; B29C 43/203; B29L 2009/00

(57) ABSTRACT

A gasket, which is configured as a single block (1), includes a guide ring (2) made of a tough material, at least one dynamically loaded sealing lip (3, 4) and at least one statically loaded sealing lip (5), wherein the dynamically loaded sealing lip (3, 4) and the statically loaded sealing lip (5) are formed of a rubber elastic material and are connected with the guide ring (2), wherein at least one first (3) and one second dynamically loaded sealing lip (4) are connected with the guide ring (2), wherein the first dynamically loaded sealing lip (3) is configured for sealing a medium (6) from a space (7) to be sealed and the second dynamically loaded sealing lip (4) is configured for sealing out contaminants (8) from the surrounding environment (9), and wherein the first sealing lip (3) is placed behind the second sealing lip (4), viewed from the surrounding environment (9) in the direction of the space (7) to be sealed off.

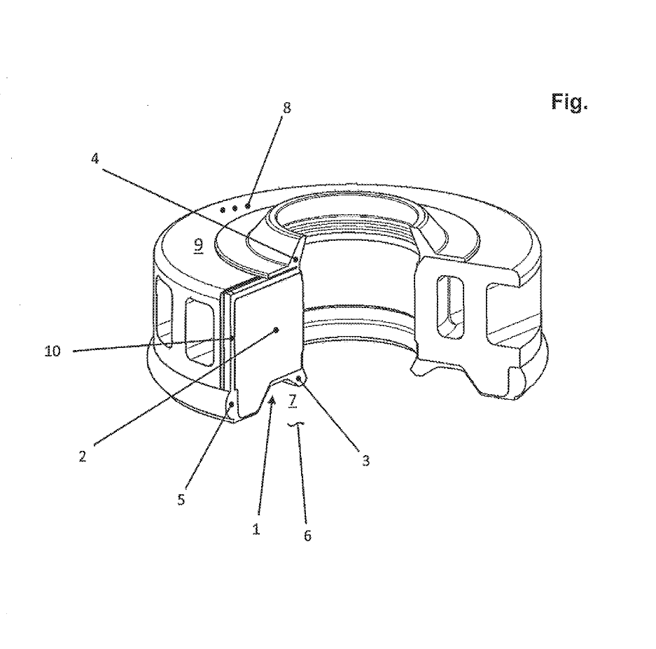

### CROSS-REFERENCE TO RELATED APPLICATIONS

This application claims the benefit and priority of German Application No. 1020140182878, filed Dec. 12, 2014. The entire disclosure of the above application is incorporated herein by reference.

### FIELD

The disclosure relates to a gasket with two dynamically loaded sealing lips and at least one statically loaded sealing lip, wherein the dynamically loaded sealing lips and the statically loaded sealing lip are formed of a rubber elastic material and wherein the first dynamically loaded sealing lip is configured to seal a medium to be sealed from a space to be sealed.

### PRIOR ART

Such a gasket is known from EP 1 703 181 A1. The gasket comprises at least one support section made of a material suitable for injection molding, wherein the sealing lips are connected with the support section in material-locked fashion. The previously known gasket does not assume a guiding function for a rod or shaft. The sealing lips and the support section consist of differing materials, wherein the binding surface is at least partially permeated by the materials of the sealing lips and of the support section. The previously known gasket is manufactured by the first material of the sealing lips being inserted by means of injection molding into a die in a first procedural step. In a second procedural step, the second material of the support ring is inserted into the die by injection molding. The first material has a lower melting point than the second material.

### BACKGROUND AND SUMMARY

The task that is the basis of the disclosure is to further develop a gasket of the type mentioned initially, so that during proper use of it, the gasket is better guided between the machine elements to be sealed, and that the dynamically loaded sealing lip facing toward a space to be sealed off is better protected against impingement of contaminants from the outside environment. Additionally, the gasket should be able to be manufactured simply and in cost effective fashion, and be reusable multiple times.

For solving the problem, a gasket is provided which is configured as a single block, comprising a guide ring made of a tough material, at least one dynamically loaded sealing lip and at least one statically loaded sealing lip, wherein the dynamically loaded sealing lip and the statically loaded sealing lip are formed of a rubber elastic material and are connected with the guide ring, wherein at least one first and one second dynamically loaded sealing lip are connected with the guide ring, wherein the first dynamically loaded sealing lip is configured for sealing a medium to be sealed from a space to be sealed off and the second dynamically loaded sealing lip is configured to seal off impurities from the surrounding environment and wherein the first sealing lip is placed behind the second sealing lip, as viewed from the surrounding environment in the direction of the space to be sealed off in a functional series.

When the gasket is used properly, the guide ring causes the mechanical loading on the sealing lips to be limited, so that the gasket overall exhibits constantly good usage properties during a lengthy period of usage.

The gasket can come to be used as a piston or rod seal, and in such a case it seals machine parts against each other, which are situated in essence concentrically to each other.

When the gasket is used properly, it may happen that the machine parts to be sealed against each other, between which the gasket is placed, exhibit an eccentric displacement in the radial direction of the piston or rod. Without the guide ring, the sealing lips in such a case would be severely deformed in undesired fashion. The result would be damage to, or destruction of, the sealing lips. Owing to the guide ring, mechanical loading on the sealing lips is limited in each case to a subcritical degree. With eccentric displacement of the machine parts to be sealed, relative to each other, initially the sealing lips would undergo elastic deformation, but only to the extent that this is not problematical in regard to their usage properties and service life. If, on the other hand, the eccentric displacement of the machine parts to be sealed is greater, the machine parts to be sealed against each other are supported by means of the guide ring, on which the sealing lips are situated. The additional mechanical loads are then absorbed by the guide ring besides, and no longer solely by the sealing lips.

Additionally, it is advantageous that the second dynamically loaded sealing lip protects the first dynamically loaded sealing lip from contamination such as dirt or liquids from the outside environment. The first sealing lip is placed behind the second sealing lip, as viewed from the surrounding environment in the direction of the space to be sealed in a functional series.

Owing to the above-mentioned form of the gasket, it exhibits constantly good usage properties during a lengthy period of usage.

What is understood by a single block in the sense of the claimed gasket, is a gasket that combines all of the possible sealing and guidance functions in one component.

According to an advantageous embodiment, provision can be made that the guide ring, as seen in cross section, is shaped essentially as a square. Such a compact guide ring exhibits good strength and shape stability under all operating conditions, so that the sealing lips connected with the guide ring are well protected from excess mechanical loading and the wear resulting therefrom.

The guide ring can be made of a polymeric material. Materials that can here be used, can for example be formed from thermoplastic materials or from Duroplast. On the one hand, such a guide ring made of the materials named can be joined well with the elastomer materials of which the sealing lips are made, and on the other hand, friction is low, when a guide ring made of such a material is braced on a machine part that is to be sealed, with the guide ring moving by translational motion, for example, as related to one of the machine parts.

The dynamically loaded sealing lips are situated radially on the inner circumference side or radially on the outer circumference side, and the statically loaded sealing lips radially on the outer circumference side or radially on the inner circumference side, of the guide ring. The arrangement of the sealing lips on the guide ring depends on whether the gasket is used to seal a rod or a piston.

Preferably provision can be made that all of the dynamically and statically loaded sealing lips are configured to interlock with each other in a single piece and be of a single material. Thus the manufacture of the gasket is simplified and made cost effective. In such a case, all of the sealing lips are connected in a single pass with the guide ring, for example by spray application.

The sealing lips can be configured to interlock with each other in a single piece and be of a single material, by at least one channel-shaped recess in the guide ring.

In regard to simplified manufacturing capabilities, preferably provision is made that several channel-shaped recesses are used, which are situated uniformly around the circumference, which is further preferred. Through connection of all the sealing lips by means of the channel-shaped recesses, the sealing lips are secured to the guide ring in especially durable fashion. Due to the recesses, the sealing lips and the guide ring are connected with each other not just in material-locked fashion, but also in shape-locked fashion. Through the multiple recesses distributed uniformly around the circumference, it is advantageous that the elastomer material of which the sealing lips consist, is connected with the guide ring during manufacture of the gasket, in particularly uniform fashion. In manufacturing the gasket, there is very little wasted material by this means.

In addition the disclosure relates to a method for manufacturing a gasket, as described previously. The method is a multi-component injection molding or pressing process. In a first procedural step, a first material of which the guide ring consists, ideally is brought by means of injection molding into a die. In a second procedural step, a second material of which the sealing lips consist, is ideally brought by injection molding into the die, with the second material being bonded in material-locked fashion with the first material of which the guide ring consists. In the second procedural step the elastomer material penetrates the channel-shaped recesses in the guide ring, so that all the sealing lips interlock with each other in a single piece and are configured to be of a single material.

The sequences in the pressing process are the following:

The single block can be produced in a 2-component process or also in a 1-component process.

With the 2-component process, first the plastic carrier piece is manufactured by injection molding, and with a second injection unit, the elastomer material is then inserted to achieve the seal geometries.

With the 1-component process, first the plastic part is manufactured by one of the customary injection molding or pressing processes. Then, the plastic piece is inserted into a tool for elastomer processing, and the appropriate seal geometries are produced with an elastomer material.

Depending on the combination of materials, it may be necessary to apply a binder layer between the materials.

In addition, the disclosure relates to use of a gasket, as described previously, in a hydraulic device.

The gasket described previously may preferably be used in vehicle shock absorbers. In such a case the piston rod of the vehicle shock absorber can be sealed by the disclosure-specific gasket against the shock absorber housing, with the piston moving back and forth by translational motion within the housing. The dynamically loaded sealing lips surround the piston rod under elastic radial pretensioning. The statically loaded sealing lip seals against the shock absorber housing.

### DRAWINGS

An embodiment example of the disclosure-specific gasket is explained in what follows in greater detail using the figure.

The figure shows one embodiment example of the disclosure-specific gasket in a schematic depiction.

### DETAILED DESCRIPTION

For better comprehension of the disclosure, a segment is depicted as having been separated out of the gasket, in able to better perceive the interior of the gasket.

The gasket shown here is a single block 1, which comprises a guide ring 2 made of a polymeric material. Radially on the inner circumference side, two dynamically loaded sealing lips 3, 4 are provided, and radially on the outer circumference side one statically loaded sealing lip 5 is provided, with the sealing lips 3, 4, 5 being configured to interlock as a single piece with each other, and consisting of a rubber elastic material.

The single block 1 shown here is used in a hydraulic device which is formed by a vehicle shock absorber.

The two dynamically loaded sealing lips 3, 4 are arranged in a functional series, so that the first sealing lip 3 is placed behind the second sealing lip 4, as viewed from the surrounding environment 9 axially in the direction of the space 7 to be sealed off, in a functional series.

The first sealing lip 3 is situated on the front side on one side of guide ring 2, the second sealing lip 4 is situated on the front side on the other side of guide ring 2. The first dynamically loaded sealing lip 3 seals off the medium 6 to be sealed from the space 7 to be sealed, while the second dynamically loaded sealing lip 4 prevents contaminants such as dust or moisture from penetrating in axially from the surrounding environment 9 in the direction of the first dynamically loaded sealing lip 3 and leading to damage or destruction of the first dynamically loaded sealing lip 3.

Multiple channel-shaped recesses 10 are provided in guide ring 2, which are situated evenly around the circumference, with one of these recesses 10 on the left sectional surface of the excised gasket being depicted. The channel-shaped recess 10 connects all of the sealing lips 3, 4 and 5 with each other.

As described before, the gasket is manufactured by a multi-component injection molding or pressing process.

The elastomer material of which the sealing lips 3, 4 and 5 consist, is connected in material-locking fashion with guide ring 2.

### REFERENCE LIST

1 Single block
2 Guide ring
3 first dynamically loaded sealing lip in the direction of space to be sealed off
4 second dynamically loaded sealing lip in the direction of the surrounding environment
5 statically loaded sealing lip to the installed space
6 medium to be sealed off
7 space to be sealed off
8 contaminants
9 surrounding environment
10 recess in 2

1. A gasket which is in the form of a single block (1), comprising a guide ring (2) made from a tough material, at least one dynamically loaded sealing lip (3, 4) and at least one statically loaded sealing lip (5), wherein the dynamically loaded sealing lip (3, 4) and the statically loaded sealing lip (5) are composed of a rubber-elastic material and are connected to the guide ring (2), wherein at least one first (3) and at least one second dynamically loaded sealing lip (4) are connected to the guide ring (2), wherein the first dynamically stressed sealing lip (3) is designed for sealing a medium (6) to be sealed from a space (7) to be sealed, and the second dynamically loaded sealing lip (4) is designed for sealing impurities (8) from the surrounding environment (9), and wherein the first sealing lip (3) is placed in a functional series behind the second sealing lip (4), as viewed from the surrounding environment (9) in the direction of the space (7) to be sealed.

2. The gasket according to claim 1, wherein the guide ring (2), as viewed in section, has a substantially square design.

3. The gasket according claim 1, wherein the guide ring (2) is composed of a polymeric material.

4. The gasket according to claim 1, wherein the dynamically loaded sealing lips (3, 4) are arranged radially on the inner circumferential side or radially on the outer circumferential side of the guide ring (2) and the statically loaded sealing lip (5) is arranged radially on the outer circumferential side or radially on the inner circumferential side of the guide ring (2).

5. The gasket according to claim 1, wherein all of the dynamically loaded sealing lips (3, 4) and statically stressed sealing lips (5) are formed from the same material and so as to merge integrally into one another.

6. The gasket according to claim 1, wherein the sealing lips (3, 4, 5) are formed from the same material and so as to merge integrally into one another by means of at least one channel-shaped recess (10) in the guide ring (2).

7. A method for producing a gasket according to claim 1 by a multi-component injection-moulding or pressing method.

8. Use of a gasket according to claim 1 in a hydraulic device.

9. Use according to claim 8, wherein the hydraulic device is formed by a motor vehicle shock absorber.

10. The gasket according claim 2, wherein the guide ring (2) is composed of a polymeric material.

11. The gasket according to claim 2, wherein the dynamically loaded sealing lips (3, 4) are arranged radially on the inner circumferential side or radially on the outer circumferential side of the guide ring (2) and the statically loaded sealing lip (5) is arranged radially on the outer circumferential side or radially on the inner circumferential side of the guide ring (2).

12. The gasket according to claim 2, wherein all of the dynamically loaded sealing lips (3, 4) and statically stressed sealing lips (5) are formed from the same material and so as to merge integrally into one another.

13. The gasket according to claim 2, wherein the sealing lips (3, 4, 5) are formed from the same material and so as to merge integrally into one another by means of at least one channel-shaped recess (10) in the guide ring (2).
